(19) United States
(12) Patent Application Publication
(10) Pub. No.: US 2010/0289453 A1
(43) Pub. Date: Nov. 18, 2010

(54) VEHICLE POWER SYSTEM

(75) Inventors: Paul Waldemar Firehammer, Saline, MI (US); John William Wagner, Ann Arbor, MI (US)

Correspondence Address: BROOKS KUSHMAN P.C./FGTL, 1000 TOWN CENTER, 22ND FLOOR, SOUTHFIELD, MI, 48075-1238, US

(73) Assignee: Ford Global Technologies, LLC, Dearborn, MI (US)

(21) Appl. No.: 12/466,462

(22) Filed: May 15, 2009

(51) Int. Cl. H02J 7/00

(52) U.S. Cl. 320/118

(57) ABSTRACT

A vehicle power system may include a plurality of series connected power storage units configured to supply power to move a vehicle, and at least one flyback switch mode converter having a plurality of primary windings and a single secondary winding. Each of the primary windings may be configured to be selectively electrically connected with a respective one of a set of the power storage units. The secondary winding may be electrically connected with a different set of the power storage units.

### BACKGROUND

A lithium-ion battery typically includes an anode, cathode and electrolyte. Lithium ions move from the anode to the cathode during discharge and from the cathode to the anode during charge.

Graphite may be used for the anode. A layered oxide (lithium cobalt oxide), polyanion (lithium iron phosphate) or spinel (lithium manganese oxide) may be used for the cathode. Other materials may also be used. Depending on the choice of material for the anode, cathode and electrolyte, the voltage, capacity and life of the lithium-ion battery may change.

Lithium-ion batteries may be electrically connected in series to form a battery pack for an automotive vehicle. Power from such a battery pack may be used to generate motive power, via an electric machine, to move the vehicle. This use of the battery pack may result in charge imbalances among the batteries.

### SUMMARY

A vehicle power system may include a plurality of series connected power storage units configured to supply power to move a vehicle, and a transformer including a plurality of primary windings and a secondary winding. Each of the primary windings may be configured to be selectively electrically connected with a respective one of a set of the power storage units. The secondary winding may be electrically connected with a different set of the power storage units.

A vehicle power system may include a plurality of charge balancing modules, each including a plurality of series connected power storage units configured to supply power to move a vehicle, and at least one transformer including a plurality of primary coils and a secondary coil. Each of the primary coils may be configured to be selectively electrically connected with at least one of the power storage units via at least one switch. The secondary coil may be electrically connected with power storage units of another of the charge balancing modules. Each of the charge balancing modules may further include circuitry configured to selectively activate the at least one switch.

A vehicle power system may include a plurality of series connected power storage units configured to supply power to move a vehicle, and at least one flyback switch mode converter having a plurality of primary windings and a single secondary winding. Each of the primary windings may be configured to be selectively electrically connected with a respective one of a set of the power storage units. The secondary winding may be electrically connected with a different set of the power storage units.

While example embodiments in accordance with the invention are illustrated and disclosed, such disclosure should not be construed to limit the invention. It is anticipated that various modifications and alternative designs may be made without departing from the scope of the invention

### BRIEF DESCRIPTION OF THE DRAWINGS

FIG. 1 is a block diagram of an embodiment of an automotive vehicle.

FIG. 2 is a block diagram of an embodiment of the traction battery pack of FIG. 1.

FIG. 3 is a schematic diagram of the traction battery pack of FIG. 2.

### DETAILED DESCRIPTION

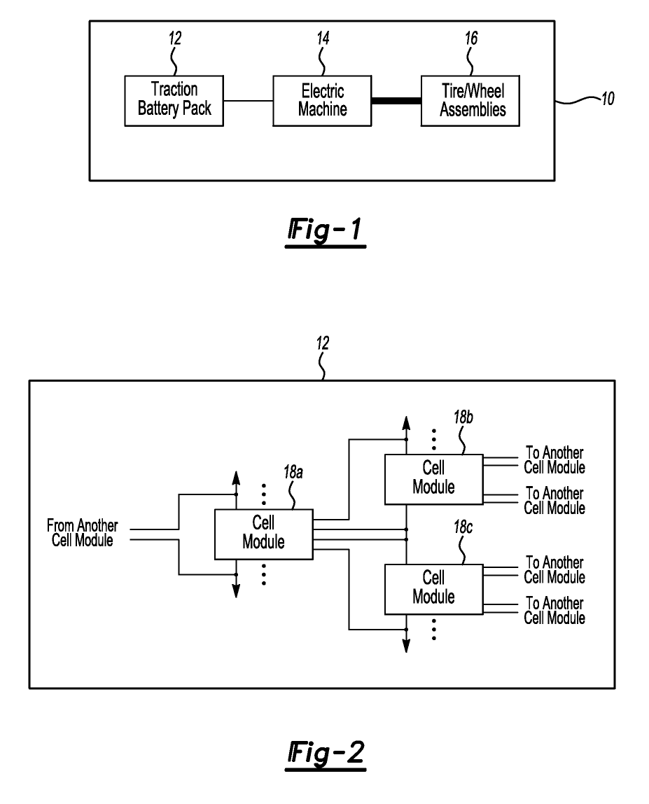

Referring now to FIG. 1, an embodiment of an automotive vehicle 10 may include a traction battery pack 12, electric machine 14 and tire/wheel assemblies 16. As known in the art, electrical energy stored in the battery pack 12 may be converted to mechanical energy by the electric machine 14 to move the tire/wheel assemblies 16 (and thus the vehicle 10); mechanical energy generated during braking events may be converted to electrical energy by the electric machine 14 and stored in the battery pack 12. Of course, the vehicle 10 may also include an engine and/or fuel cell stack, as well as other related powertrain components (not shown) adapted to move the tire/wheel assemblies 16 as known in the art.

Referring now to FIG. 2, an embodiment of the battery pack 12 includes a plurality of cell modules 18n (18a, 18b, 18c). Each of the cell modules 18n includes, inter alia, a plurality of power storage units, (e.g., lithium-ion batteries, etc.), electrically connected in series. (The cell modules 18n are also electrically connected in series.) Other cell/module arrangements, however, are also possible. As explained below, a particular power storage unit of one of the cell modules 18n (such as the cell module 18a) may be electrically connected with power storage units of another of the cell modules 18n (such as the cell module 18b) such that energy from the power storage unit of the cell module 18a may be transferred to the power storage units of the cell module 18b to effectuate cell balancing.

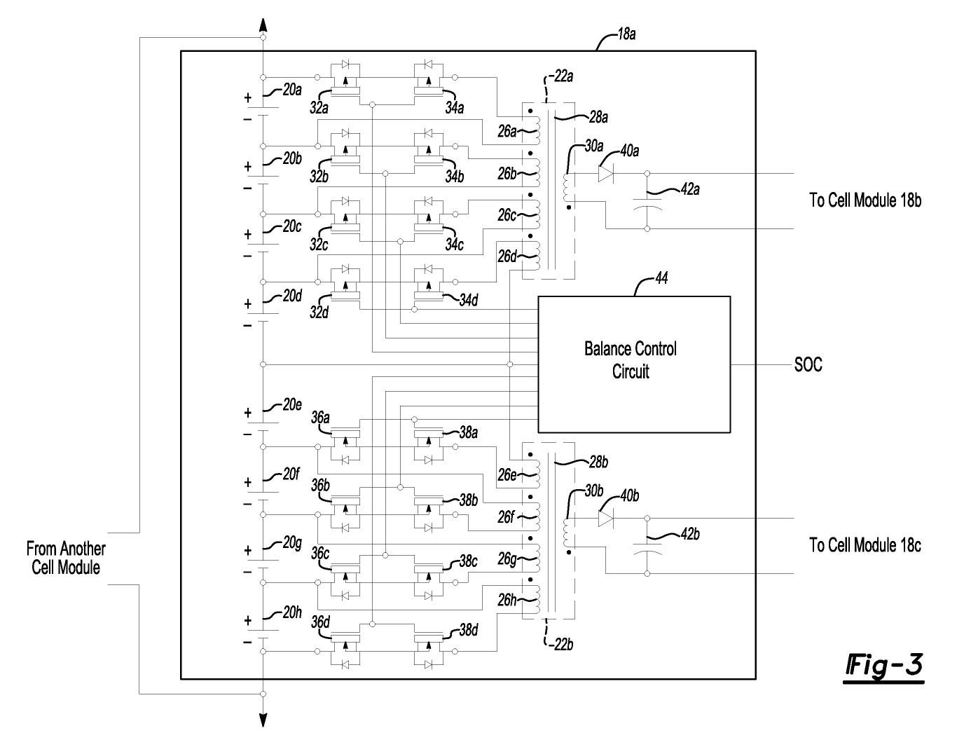

Referring now to FIG. 3, an embodiment of the cell module 18a includes a plurality of power storage units 20n (20a-20h). In the embodiment of FIG. 3, the power storage units 20n are lithium-ion batteries. Any suitable power storage units (e.g., capacitors, nickel metal hydride batteries, etc.) in any suitable quantities, however, may be used. As discussed above, the power storage units 20n are electrically connected in series.

The cell module 18a may also include transformers 22a, 22b. The transformer 22a includes a plurality of primary windings 26a-26d, a core 28a, and secondary winding 30a. Likewise, the transformer 22b includes a plurality of primary windings 26e-26h, a core 28b, and secondary winding 30b. A primary winding is associated with each of the power storage units. (That is, the number of power storage units 20n matches the number of primary windings 26n.) In other embodiments, however, these numbers need not match. For example, every two power storage units may be associated with a primary winding, etc. As discussed below, the transformer 22a may be electrically connected with the power storage units 20a-20d; the transformer 22b may be electrically connected with the power storage units 20e-20h.

The cell module 18a may further include a plurality of electrical switches 32n (32a-32d), 34n (34a-34d), 36n (36a-36d), 38n (38a-38d). The electrical switches 32n, 34n may electrically connect the power storage units 20a-20d with the transformer 22a. The electrical switches 36n, 38n may electrically connect the power storage units 20e-20h with the transformer 22b. In the embodiment of FIG. 3, the electrical switches 32n, 34n are p-type MOSFETS and the electrical switches 36n, 38n are n-type MOSFETS. Of course, any suitable electrical switching type/arrangement may be used.

The secondary windings 30a, 30b may be electrically connected with power storage units of other cell modules 18n. Similarly, the power storage units 20n may be electrically connected with a secondary winding of another cell module 18n, etc. In the embodiment of FIG. 3, the secondary winding 30a is electrically connected with power storage units of the cell module 18b, and the secondary winding 30b is electrically connected with power storage units of the cell module 18c. In other embodiments, the secondary windings 30a, 30b may be electrically connected with power storage units of all the cell modules 18n; the secondary windings 30a, 30b may be electrically connected with power storage units of the same cell module 18n, etc.

Diodes 40a, 40b and capacitors 42a, 44b may be associated with the electrical connections between the secondary windings 30a, 30b and the cell modules 18b, 18c. As known in the art, the diode 40a prevents current from flowing through the secondary winding 30a while current is ramping up in any of the primary windings 26a-26d; the diode 40b prevents current from flowing through the secondary winding 30b while current is ramping up in any of the primary windings 26e-26h. As also known in the art, the capacitors 42a, 42b smooth the current output by the secondary windings 30a, 30b respectively.

To electrically connect the power storage unit 20a with the primary winding 26a, the switches 32a, 34a may be activated. Current will flow (clockwise as illustrated) from the positive terminal of the power storage unit 20a, through the primary winding 26a (thus building an electromagnetic field), and to the negative terminal of the power storage unit 20a. As discussed above, while current is ramping up in the primary winding 26a, the diode 40a will prevent current flow through the secondary winding 30a (given the dot convention of the primary winding 26a and secondary winding 30a). Once the switches 32a, 34a are deactivated, current will flow (clockwise as illustrated) from the secondary winding 30a (due to the collapse of the electromagnetic field built up by the primary winding 26a) to power storage units of the cell module 18b. (Of course, the turns ratio of the primary winding 26a to the secondary winding 30a may be selected such that an appropriate voltage is output to the cell module 18b.) The other power storage units 20b-20h may be electrically connected with their associated transformer 22a, 22b by similar operation.

As apparent to those of ordinary skill, the transformers 22a, 22b, and associated components, each form a flyback switch mode converter with multiple primary windings and a single secondary winding. The cell module 18a of FIG. 3 has two such flyback switch mode converters. In other embodiments, any suitable number of such flyback switch mode converters may be used. For example, a cell module may include twenty four (24) power storage units and three (3) switch mode converters of the type described herein. Each switch mode converter may be arranged to be electrically connected with eight (8) of the power storage units, etc.

The cell module 18a may further include a balance control circuit 44. The control circuit 44 facilitates the activation/deactivation of the switches 32n, 34n, 36n, 38n based on received state of charge information (determined in any suitable manner) regarding the power storage units 20n. In the embodiment of FIG. 3, the control circuit 44 is electrically connected with gates of the switches 32n, 34n, 36n, 38n: the control circuit 44 has an electrical connection with gates of the switches 32a, 34a, the control circuit has an electrical connection with gates of the switches 36a, 38a, etc. The control circuit 44 also has its reference electrically connected with the mid-point of the power storage units 20n.

Each of the cell modules 18n need not have its own control circuit 44. In some embodiments, a single balance control circuit may be arranged to facilitate the activation/deactivation of switches of some/all of the cell modules 18n. Other arrangements are also possible.

To activate the switches 32a, 34a, the control circuit 44 pulls the gate voltages of the switches 32a, 34a negative (with respect to their source leads) via connection to the reference of the control circuit 44. Switches 32b-32d, 34b-34d may be activated in a similar manner. To activate the switches 36a, 38a, the control circuit 44 drives the gate voltages of the switches 36a, 38a positive (with respect to their source leads) via connection to the reference of the control circuit 44. Switches 36b-36d, 38b-38d may be activated in a similar manner.

If any of the power storage units 20n has a state of charge greater than a desired threshold, its additional energy may be passed to power storage units of other cell modules 18n. For example, if the power storage unit 20g has a state of charge greater than the desired threshold (as indicated by state of charge information received by the control circuit 44), the control circuit 44 may drive gates of the switches 36c, 38c positive (activating the switches 36c, 38c). Energy stored by the power storage unit 20g may thus be transferred (via the transformer 22b) to power storage units of the cell module 18c until the state of charge of the power storage unit 20g achieves the desired range.

If any of the power storage units 20n has a state of charge less than a desired threshold, energy from the other power storage units 20n may be passed to power storage units of other cell modules 18n. For example, if the power storage unit 20d has a state of charge less than the desired threshold, the control circuit 44 may utilize the switches 32a, 34a to transfer power from the power storage unit 20a via the transformer 22a; the control circuit 44 may utilize the switches 32b, 34b to transfer power from the power storage unit 20b via the transformer 22a, etc. This power transfer may continue until the states of charge of the power storage units 20a-20h are approximately equal. Energy may then be driven into the power storage units 20a-20h (from other cell modules 18n) to raise their states of charge to a desired level. Other control schemes are also possible.

While embodiments of the invention have been illustrated and described, it is not intended that these embodiments illustrate and describe all possible forms of the invention. The words used in the specification are words of description rather than limitation, and it is understood that various changes may be made without departing from the spirit and scope of the invention.

What is claimed:

1. A vehicle power system comprising:
a plurality of series connected power storage units configured to supply power to move a vehicle; and
a transformer including a plurality of primary windings and a secondary winding, each of the primary windings configured to be selectively electrically connected with a respective one of a set of the power storage units, the secondary winding electrically connected with a different set of the power storage units.

2. The system of claim 1 wherein each of the primary windings is configured to be selectively electrically connected with a respective one of a set of the power storage units based on state of charge information about the power storage units.

3. The system of claim 1 wherein each of the primary windings is configured to be selectively electrically connected with a respective one of a set of the power storage units via at least one electrical switch.

4. The system of claim 3 wherein the at least one electrical switch is a field effect transistor.

5. The system of claim 1 wherein the power storage units are batteries.

6. The system of claim 5 wherein the batteries are lithium-ion batteries.

7. A vehicle power system comprising:
a plurality of charge balancing modules, each including (i) a plurality of series connected power storage units configured to supply power to move a vehicle, (ii) at least one transformer including a plurality of primary coils and a secondary coil, each of the primary coils configured to be selectively electrically connected with at least one of the power storage units via at least one switch, the secondary coil electrically connected with power storage units of another of the charge balancing modules, and (iii) circuitry configured to selectively activate the at least one switch.

8. The system of claim 7 wherein the circuitry is configured to selectively activate the at least one switch based on state of charge information about the power storage units.

9. The system of claim 7 wherein the at least one switch is a field effect transistor.

10. The system of claim 7 wherein the power storage units are batteries.

11. The system of claim 10 wherein the batteries are lithium-ion batteries.

12. A vehicle power system comprising:
a plurality of series connected power storage units configured to supply power to move a vehicle; and
at least one flyback switch mode converter having a plurality of primary windings and a single secondary winding, each of the primary windings configured to be selectively electrically connected with a respective one of a set of the power storage units, the secondary winding electrically connected with a different set of the power storage units.

13. The system of claim 12 wherein each of the primary windings is configured to be selectively electrically connected with a respective one of a set of the power storage units based on state of charge information about the power storage units.

14. The system of claim 12 wherein each of the primary windings is configured to be selectively electrically connected with a respective one of a set of the power storage units via at least one electrical switch.

15. The system of claim 14 wherein the at least one electrical switch is a field effect transistor.

16. The system of claim 12 wherein the power storage units are batteries.

17. The system of claim 16 wherein the batteries are lithium-ion batteries.
